(19) United States
(12) Patent Application Publication
(10) Pub. No.: US 2026/0267119 A1
(43) Pub. Date: Sep. 10, 2026

(54) CAMERA MODULE

(71) Applicant: SAMSUNG ELECTRO-MECHANICS CO., LTD., Suwon-si (KR)

(72) Inventors: Sang Hun HAN, Suwon-si (KR); Tae Won KANG, Suwon-si (KR); Ji Eun JEONG, Suwon-si (KR); Jae Kyung KIM, Suwon-si (KR); Chul Jin KIM, Suwon-si (KR)

(73) Assignee: SAMSUNG ELECTRO-MECHANICS CO., LTD., Suwon-si (KR)

(21) Appl. No.: 19/447,354

(22) Filed: Jan. 13, 2026

(30) Foreign Application Priority Data
Mar. 10, 2025 (KR) 10-2025-0030716
Sep. 15, 2025 (KR) 10-2025-0131560

(51) Int. Cl. G02B 13/00; G03B 5/02; G03B 30/00; H04N 23/51; H04N 23/55

(52) U.S. Cl. CPC G02B 13/0065; G03B 5/02; G03B 30/00; H04N 23/51; H04N 23/55; G03B 2205/0007

(57) ABSTRACT

A camera module includes a housing in which a reflective member is disposed, a lens module disposed on an object-side of the reflective member, a carrier disposed to surround the reflective member, and an image sensor on which light emitted from the reflective member is incident, wherein the carrier includes an opening portion on one side so that the reflective member and the image sensor directly face each other, and wherein a reinforcing member is disposed on at least one surface of the carrier and is formed of a material having higher rigidity than that of the carrier.

### CROSS-REFERENCE TO RELATED APPLICATIONS

This application claims the benefit under 35 USC 119(a) of Korean Patent Application No. 10-2025-0030716 filed on Mar. 10, 2025, and Korean Patent Application No. 10-2025-0131560 filed on Sep. 15, 2025, in the Korean Intellectual Property Office, the entire disclosures of which are incorporated herein by reference for all purposes.

### BACKGROUND

### 1. Field

The present disclosure relates to a camera module.

### 2. Description of the Background

Camera modules equipped with a reflective member (hereinafter, folded camera modules) are being developed. The reflective member of the folded camera module bends the light path, which may improve space efficiency when applied to mobile devices with space constraints.

Folded camera modules have an advantage of allowing the lenses to be disposed in a direction other than a thickness direction of the mobile devices, but there may be a problem that a length of the module may become excessively long depending on the number of lenses.

Accordingly, a structure in which a lens is disposed in front of the reflective member has recently been proposed.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing in which a reflective member is disposed, a lens module disposed on an object-side of the reflective member, a carrier disposed to surround the reflective member, and an image sensor on which light emitted from the reflective member is incident, wherein the carrier includes an opening portion on one side so that the reflective member and the image sensor directly face each other, and wherein a reinforcing member is disposed on at least one surface of the carrier and is formed of a material having higher rigidity than that of the carrier.

The reflective member and the lens module may be disposed in an optical axis direction, and the reflective member and the image sensor may be disposed in a direction perpendicular to an optical axis.

The reflective member may include an incident surface facing the lens module, an exit surface facing the image sensor, a reflective surface disposed obliquely relative to the incident surface and the exit surface, and two side surfaces that are disposed parallel to each other while contacting the incident surface, the exit surface, and the reflective surface, wherein the carrier may be disposed to surround the reflective surface and the two side surfaces.

The reinforcing member may be disposed on one surface perpendicular to an optical axis of the carrier.

The one surface of the carrier may have a ‘ [symbol] ’ shape when viewed from an optical axis direction, and the reinforcing member may have a shape corresponding to the one surface of the carrier.

The reinforcing member may include a first external edge adjacent to the housing and a first internal edge adjacent to the reflective member, and a rib extending in an optical axis direction from at least a portion of the first internal edge.

The carrier may further include a second external edge adjacent to the housing and a second internal edge adjacent to the reflective member, and a protrusion protruding in the optical axis direction from at least a portion of the second internal edge. The rib may be disposed on the protrusion.

An extension direction of the rib and a protrusion direction of the protrusion may be in a direction approaching the lens module.

The reinforcing member may be formed integrally with the carrier.

The lens module may be disposed on the carrier.

In another general aspect, a camera module includes a housing in which a reflective member is disposed, a carrier disposed in the housing and configured to move in an optical axis direction relative to the housing together with a lens module, and a stopper coupled to the carrier, wherein the carrier has a shape in which one side is open in a direction perpendicular to an optical axis, and wherein a reinforcing member is disposed on the carrier and is formed of a material having higher rigidity than that of the carrier.

The stopper may include a cover portion covering an upper portion of the carrier, and a plurality of coupling portions extended in the optical axis direction from the cover portion and disposed to face the carrier in the direction perpendicular to the optical axis. The stopper may be coupled to the carrier through the plurality of coupling portions.

The reinforcing member may be disposed on a bottom surface of the carrier. The bottom surface of the carrier and the reinforcing member disposed on the bottom surface of the carrier may have a ‘ [symbol] ’ shape when viewed from the optical axis direction.

The reinforcing member may further include a rib that is bent and extended in the optical axis direction at a portion of the reinforcing member that is disposed on the bottom surface of the carrier.

The carrier may further include a protrusion protruding in the optical axis direction from the bottom surface of the carrier. The rib may be disposed on the protrusion.

The reinforcing member may further include a first external edge adjacent to a housing and a first internal edge adjacent to the optical axis. The rib may be disposed along at least a portion of the first internal edge of the reinforcing member.

The carrier may include a second external edge adjacent to the housing and a second internal edge adjacent to the optical axis, wherein the protrusion may be disposed along at least a portion of the second internal edge of the carrier.

The camera module may further include the reflective member disposed in the housing, and an image sensor spaced apart from the reflective member in the direction perpendicular to the optical axis, wherein the reflective member and the image sensor may directly face each other in the direction perpendicular to the optical axis, through the one open side of the carrier.

The lens module may be configured to move in a first axis direction perpendicular to the optical axis direction and a second axis direction perpendicular to the optical axis direction and the first axis direction relative to the carrier.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of the camera module according to an embodiment of the present disclosure.

FIG. 3 is an exploded bottom perspective view of the housing and reflective module of FIG. 2.

FIG. 4 is a cross-sectional view taken along line I-I′ of FIG. 1.

FIG. 5 is an exploded perspective view of a portion (reflective module and housing) of a camera module according to an embodiment of the present disclosure.

FIG. 6 is a perspective view illustrating a combined state of a reflective module and a housing according to an embodiment of the present disclosure.

FIG. 7 is a cross-sectional view taken along line II-II′ of FIG. 1.

FIG. 8 is an exploded perspective view of a portion (lens module and driving-related components) of a camera module according to an embodiment of the present disclosure.

FIG. 9 is a perspective view illustrating a state in which a cover member is coupled to a carrier according to an embodiment of the present disclosure.

FIG. 10 is a perspective view of a carrier according to an embodiment of the present disclosure.

FIG. 11 is an exploded perspective view of a carrier according to an embodiment of the present disclosure.

FIG. 12 is a cross-sectional view of III-III′ of FIG. 10.

FIG. 13 is an exploded perspective view of a carrier according to another embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this specification, an optical axis direction may mean a direction extending vertically in the optical axis (Z-axis) or a direction parallel to the optical axis (Z-axis). Additionally, a first axis direction and a second axis direction may refer to directions that are perpendicular to each other while intersecting the optical axis (Z-axis). For example, the first axis (X-axis) direction may refer to a direction perpendicular to the optical axis (Z-axis), and the second axis (Y-axis) direction may refer to a direction perpendicular to both the optical axis (Z-axis) and the first axis (X-axis).

The present disclosure relates to a camera module, and more specifically, a camera module that may be mounted on a portable electronic device such as a mobile communication terminal, a smartphone, a tablet PC, and the like.

An aspect of the present disclosure is to provide a camera module that has improved structural rigidity.

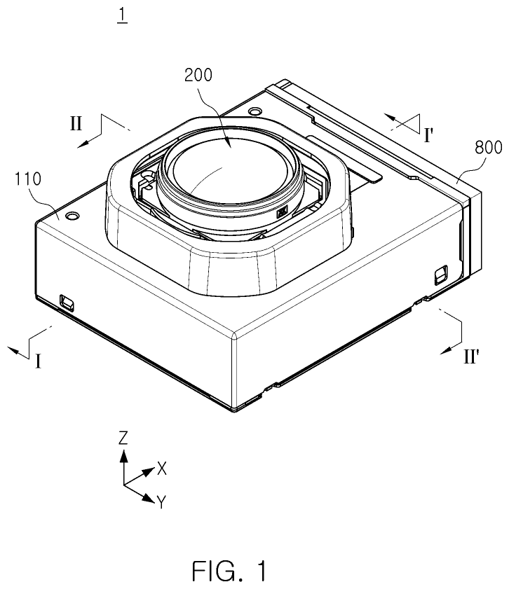

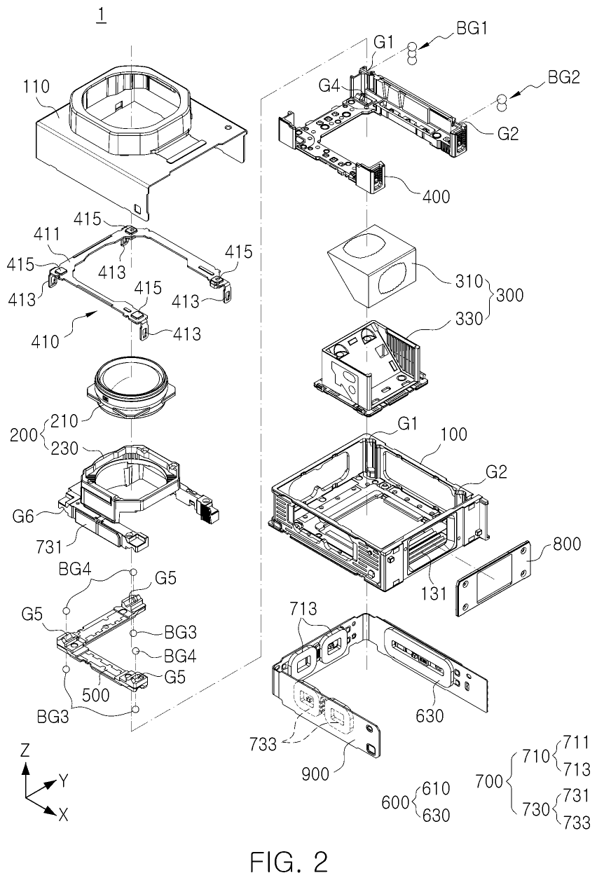

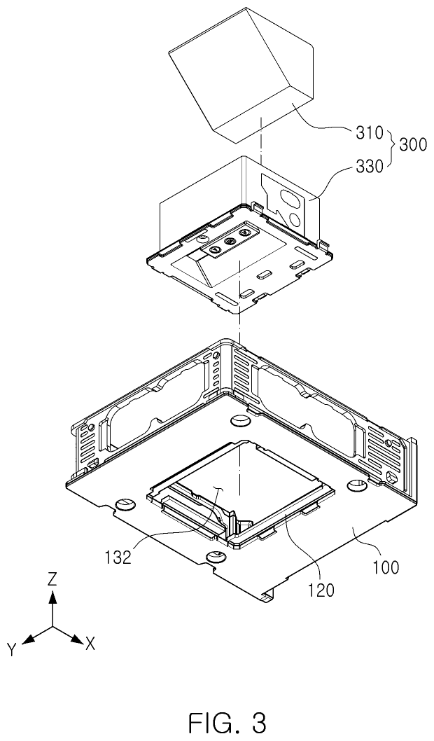

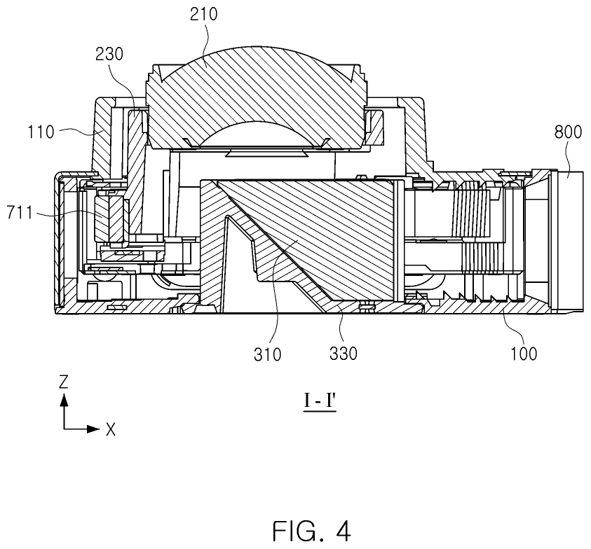

FIG. 1 is a perspective view of a camera module according to an embodiment of the present disclosure, FIG. 2 is an exploded perspective view of a camera module according to an embodiment of the present disclosure, FIG. 3 is an exploded bottom perspective view of the housing and reflective module of FIG. 2, and FIG. 4 is a cross-sectional view taken along line I-I′ of FIG. 1.

A camera module 1 according to an embodiment of the present disclosure may be manufactured compactly overall. In an embodiment, the camera module 1 may have similar lengths in the first axis (X-axis) direction and the second axis (Y-axis) direction, perpendicular to the optical axis (Z-axis).

The camera module 1 may include a housing 100, a lens module 200, and a reflective module 300.

The lens module 200 and the reflective module 300 are disposed in the optical axis (Z-axis) direction and may be disposed in the housing 100. In an embodiment, light incident on the camera module 1 may pass through the lens module 200 and may be incident on the reflective module 300.

The lens module 200 may include a lens barrel 210 and a lens holder 230. One or more lenses may be mounted on the lens barrel 210 in the optical axis (Z-axis) direction, and the lens barrel 210 may be coupled to the lens holder 230.

The lens barrel 210 and the lens holder 230 may be moved together. That is, the lens module 200 may be a movable member.

The reflective module 300 may include a reflective member 310 and a reflective member holder 330. The reflective member 310 may be disposed in the internal space of the housing 100, and the reflective member holder 330 may be coupled to a bottom surface of the housing 100.

### That Is, the Reflective Module 300 May Be a Fixed Member.

The lens module 200 may be moved in the optical axis (Z-axis) direction and in the direction perpendicular to the optical axis (Z-axis). In more detail, the lens module 200 may adjust focus while moving in the optical axis (Z-axis) direction and correct shake while moving in a direction perpendicular to the optical axis (Z-axis), for example, in the first axis (X-axis) direction and the second axis (Y-axis) direction. Movement of the lens module 200 may be movement relative to the housing 100 and the reflective module 300.

The camera module 1 may include a carrier 400 and a frame 500 guiding the movement of the lens module 200.

The carrier 400 is a member guiding movement of the lens module 200 in the optical axis (Z-axis) direction, and may move in the optical axis (Z-axis) direction together with the lens module 200.

The frame 500 is a member guiding movement in a direction perpendicular to the optical axis (Z-axis) of the lens module 200, and may be moved in the first axis (X-axis) direction or the second axis (Y-axis) direction (based on the drawing, the first axis (X-axis) direction) together with the lens module 200. Meanwhile, since the frame 500 is supported on the carrier 400, it may also move in the optical axis (Z-axis) direction.

The camera module 1 may include an image sensor module 800 including an image sensor and a printed circuit board on which the image sensor is mounted.

The image sensor module 800 may be disposed in the housing 100. A through-hole (hereinafter, “first through-hole”) 131 is formed on a surface of the housing 100 where the image sensor module 800 is disposed, and the image sensor may be disposed such that an imaging surface, where light is received, faces the internal space of the housing 100 through the first through-hole 131. The image sensor may directly face an exit surface 313 of the reflective member 310 through the first through-hole 131.

The camera module 1 may include a case 110 coupled to the housing 100.

The case 110 may be coupled to the housing 100 and surround the housing 100. The case 110 may form most of the exterior of the camera module 1, and may protect components disposed inside the housing 100 and shield electromagnetic waves.

Below, the structure and operation of the camera module 1 are described in detail, focusing on the listed components.

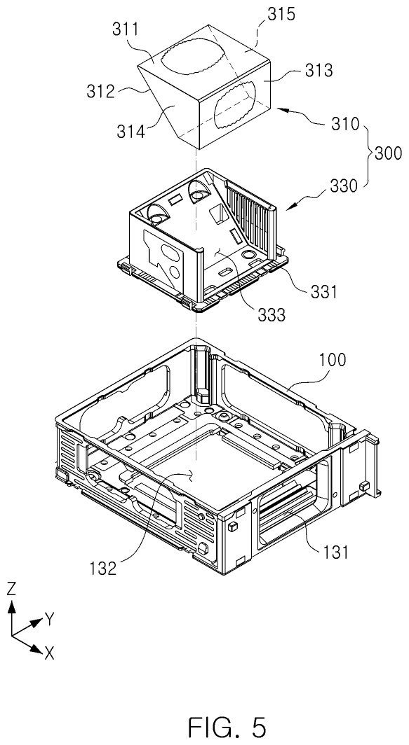

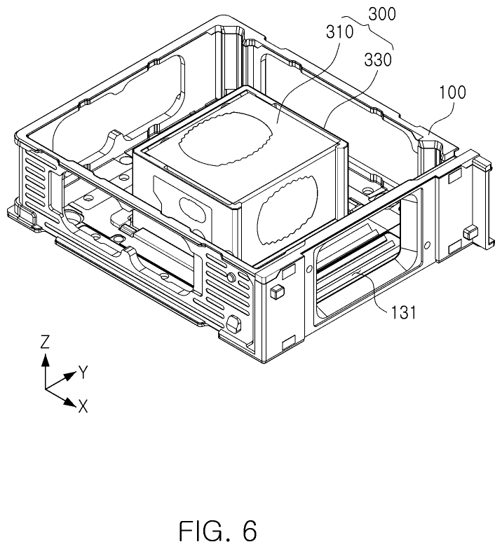

FIG. 5 is an exploded perspective view of a portion (reflective module and housing) of a camera module according to an embodiment of the present disclosure, and FIG. 6 is a perspective view illustrating a combined state of a reflective module and a housing according to an embodiment of the present disclosure.

The reflective member 310 may change the direction of propagation of light incident on the camera module 1. For example, the reflective member 310 may reflect light incident in the optical axis (Z-axis) direction through the lens module 200 in the first axis (X-axis) direction. In an embodiment, the reflective member 310 may be a prism.

An incident surface 311 of the reflective member 310 may face the lens module 200, and the exit surface 313 may face the imaging surface of the image sensor. The reflective surface 312 may be disposed at an angle of approximately 45 degrees relative to the incident surface 311 and the exit surface 313 to induce total reflection of light. Additionally, the reflective member 310 may include two parallel side surfaces 314 and 315 supported by the reflective member holder 330. In addition to the two side surfaces 314 and 315, the reflective surface 312 may also be supported on the reflective member holder 330.

The reflective module 300 may be coupled to the bottom surface of the housing 100 while being disposed at the bottom portion of the housing 100.

With an upward movement (+Z-direction) of the reflective module 300, the reflective member 310 may be disposed in an internal space of the housing 100 by passing through a through-hole (hereinafter, second through-hole) 132 formed on the bottom surface of the housing 100 while being disposed in the reflective member holder 330.

The reflective member holder 330 may include a flange portion 331 parallel to the bottom surface of the housing 100 and a reflective member mounting portion 333 extending from the flange portion 331 in a direction perpendicular to the flange portion 331.

With the upward movement (+Z-direction) of the reflective module 300, the reflective member mounting portion 333 in which the reflective member 310 is disposed may be disposed in the internal space of the housing 100 by passing through the second through-hole 132.

Meanwhile, the flange portion 331 may be disposed on the outside of the bottom surface of the housing 100 without passing through the second through-hole 132.

The flange portion 331 may overlap the bottom surface of the housing 100 around the second through-hole 132 in the optical axis (Z-axis) direction. A mounting groove 120 may be formed along the edge of the second through-hole 132 on the bottom surface of the housing 100, and the flange portion 331 may be disposed in the mounting groove 120. The reflective module 300 may be coupled to the bottom surface of the housing 100 with the flange portion 331 disposed in the mounting groove 120. The flange portion 331 may be fixed to the bottom surface of the housing 100 so that the reflective module 300 is not separated from the housing 100, and the method of fixing is not limited to a specific method.

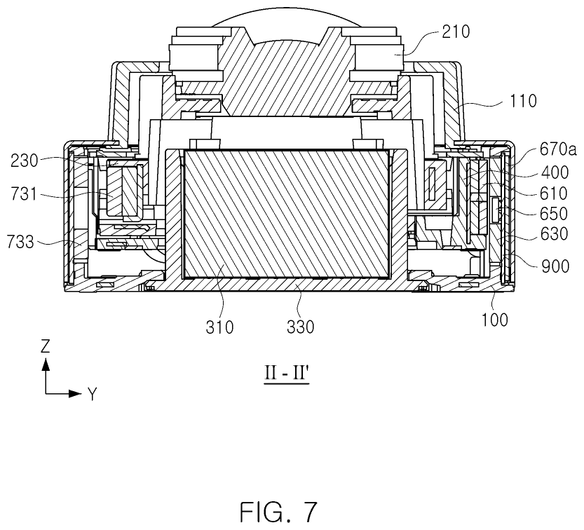

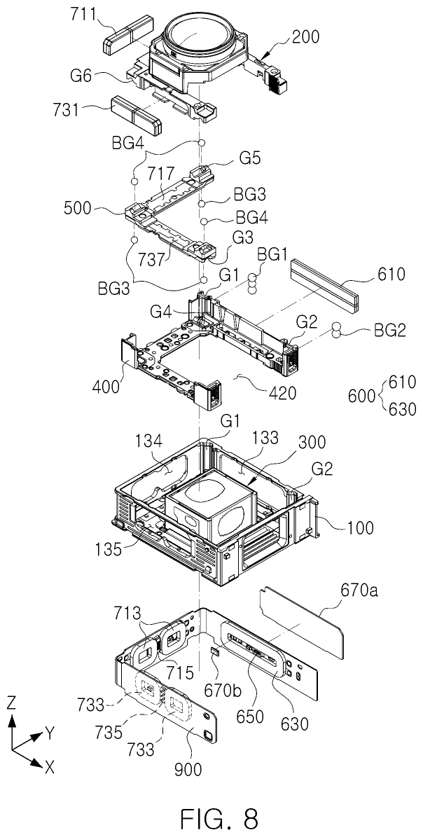

FIG. 7 is a cross-sectional view of II-II′ of FIG. 1, and FIG. 8 is an exploded perspective view of a portion (lens module and driving-related components) of a camera module according to an embodiment of the present disclosure.

The lens module 200 may be spaced apart from the reflective module 300 in the optical axis direction (Z-axis direction), and the driving units 600 and 700 generating driving force to move the lens module 200 may be spaced apart from the reflective module 300 in a direction, perpendicular to the optical axis (Z-axis).

The driving units 600 and 700 generating driving force to move the lens module 200 may be disposed on the carrier 400 and the lens holder 230. A first driving unit (or focus adjustment driving unit) 600 forming driving force to move the lens module 200 in the optical axis direction (Z-axis direction) is disposed on the carrier 400, and a second driving unit (or shake correction driving unit) 700 forming driving force to move the lens module 200 in the first axis (X-axis) direction and the second axis (Y-axis) direction, perpendicular to the optical axis (Z-axis) may be disposed in the lens holder 230.

As described above, the movement of the lens module 200 may be guided by the carrier 400 and the frame 500.

The carrier 400 and frame 500 may be disposed in the internal space of the housing 100.

The carrier 400 may be disposed to surround the reflective module 300 in the internal space of the housing 100. The carrier 400 may be formed in a ‘ [symbol] ’ shape when viewed from the optical axis direction (Z-axis direction). The carrier 400 is formed in a ‘ [symbol] ’ shape and surrounds the reflective module 300 while not blocking the exit surface 313 of the reflective member 310. The reflective member 310 may directly face the image sensor through an opening portion (window) 420 of the carrier 400. The reflective member 310 and the image sensor may face each other directly in the first axis (X-axis) direction.

The carrier 400 may be supported in a direction, perpendicular to the optical axis (Z-axis) on the housing 100. Based on the drawing, the carrier 400 may be supported on the housing 100 in the second axis (Y-axis) direction.

The frame 500 may be disposed between the lens holder 230 and the carrier 400. For example, the lens holder 230, frame 500, and carrier 400 may be disposed in sequence in the optical axis direction (Z-axis direction).

The frame 500 may have a ‘ [symbol] ’ shape when viewed from the optical axis direction (Z-axis direction) and may be supported by the carrier 400 in the optical axis direction (Z-axis direction). Additionally, the frame 500 may support the lens holder 230 in the optical axis direction (Z-axis direction).

Below, the focus adjustment operation and shake correction operation of the camera module 1 are described.

The focus of the camera module 1 may be adjusted by moving the lens module 200 in the optical axis direction (Z-axis direction).

The camera module 1 may include a first driving unit 600 that generates driving force to move the lens module 200 in the optical axis direction (Z-axis direction).

The first driving unit 600 may include a first magnet 610 and a first coil 630.

The first magnet 610 may be disposed on one side surface of the carrier 400, and the first coil 630 may be disposed on one side surface of the housing 100 facing the one side surface of the carrier 400 on which the first magnet 610 is disposed. The first magnet 610 and the first coil 630 may face each other in a direction, perpendicular to the optical axis (Z-axis), or in the second axis (Y-axis) direction based on the drawing.

One surface of the first magnet 610, for example, the surface facing the first coil 630, may be provided with an N-pole region (or S-pole region), a neutral region, and an S-pole region (or N-pole region) in that order in the optical axis direction (Z-axis direction).

The first coil 630 may be mounted on a main board 900 and disposed in the housing 100. The housing 100 may include a through-hole (hereinafter, third through hole) 133 penetrating one side surface in which the first coil 630 is disposed, and the first coil 630 may be exposed to an internal space of the housing 100 through the third through-hole 133 and may directly face the first magnet 610.

When power is applied to the first coil 630, driving force may be generated in the direction of the optical axis (Z-axis direction), a direction perpendicular to the direction in which they face each other, by the electromagnetic force between the first magnet 610 and the first coil 630. The carrier 400 may be moved in the optical axis direction (Z-axis direction) by the above driving force.

Ball groups BG1 and BG2 may be disposed between the carrier 400 and the housing 100. The ball groups BG1 and BG2 may be disposed between one side surface of the carrier 400 where the first magnet 610 is disposed and one side surface of the housing 100 where the first coil 630 is disposed, and may reduce friction when the carrier 400 moves relative to the housing 100.

The ball groups BG1 and BG2 may include a first ball group BG1 and a second ball group BG2 spaced apart in a direction perpendicular to the optical axis (Z-axis). The first ball group BG1 and the second ball group BG2 may be spaced apart from each other with the first magnet 610 and the first coil 630 interposed therebetween.

The first ball group BG1 and the second ball group BG2 may each include a plurality of balls disposed in the optical axis direction (Z-axis direction). A plurality of balls may be accommodated in guide grooves G1 and G2 formed in the carrier 400 and the housing 100.

The guide grooves G1 and G2 may be formed on the facing surfaces of the carrier 400 and the housing 100, respectively.

A first guide groove G1 for accommodating the first ball group BG1 and a second guide groove G2 for accommodating the second ball group BG2 may be formed on the opposing surfaces of the carrier 400 and the housing 100, respectively.

The first guide groove G1 and the second guide groove G2 may extend in the optical axis direction (Z-axis direction). Accordingly, the plurality of balls disposed in the optical axis direction (Z-axis direction) of the first ball group BG1 and the second ball group BG2 may move in a rolling motion in the optical axis direction (Z-axis direction) while being accommodated in the first guide groove G1 and the second guide groove G2.

The first ball group BG1 may contain a greater number of balls than the second ball group BG2. Additionally, at least a portion of the balls of the first ball group BG1 may form more contact points with the guide groove than the balls of the second ball group BG2. At this time, the first ball group BG1 may function as a main guide, and the second ball group BG2 may function as an auxiliary guide.

For example, the first ball group BG1 may include three balls, and the second ball group BG2 may include two balls. Additionally, the first ball group BG1 may form up to four contact points with the first guide groove G1, for example, two contact points each with the carrier 400 and the housing 100, and the second ball group BG2 may form up to three contact points with the second guide groove G2, for example, two-point contact with the carrier 400 and one-point contact with the housing 100 (or vice versa). To have a different number of contact points, the second guide groove G2 may include a guide groove having a different cross-sectional shape from the first guide groove G1.

A first yoke 670a may be disposed in the housing 100 to face the first magnet 610. The first yoke 670a may be attached to an external surface of the main board (900) disposed in the housing 100, for example, the opposite surface to the surface on which the first coil 630 is disposed.

The first magnet 610 and the first yoke 670a may generate an attractive force between each other. The first yoke 670a may be formed of a material including a magnetic substance, and the first magnet 610 and the first yoke 670a may generate an attractive force in a direction facing each other.

By the attractive force of the first magnet 610 and the first yoke 670a, the carrier 400 may be supported in close contact with the housing 100 with the ball groups BG1 and BG2 interposed therebetween, and the ball groups BG1 and BG2 may also be prevented from coming off.

In addition to the first yoke 670a, an auxiliary yoke 670b may be further disposed in the housing 100. The auxiliary yoke 670b may also be disposed to face the first magnet 610. The auxiliary yoke 670b may be mounted on one surface of the main substrate 900 together with the first coil 630. The auxiliary yoke 670b may be disposed closer to the first ball group BG1 than to the second ball group BG2.

The auxiliary yoke 670b may be formed of a material including a magnetic substance and may generate an attractive force in a direction facing the first magnet 610.

By means of the auxiliary yoke 670b, the attractive force generated by the first magnet 610, the first yoke 670a, and the auxiliary yoke 670b may act more strongly at a position closer to the first ball group BG1, which is the main guide, and thus the driving stability of the carrier 400 may be improved.

A first position sensor 650 detecting the position of the carrier 400 in the optical axis direction (Z-axis direction) may be disposed in the housing 100. The first position sensor 650 may be provided on one surface of the main board 900 together with the first coil 630 and may be disposed to face the neutral region of the first magnet 610.

The first position sensor 650 may detect the position of the carrier 400 in the optical axis direction (Z-axis direction) by detecting a change in the magnetic field. In an embodiment, the first position sensor 650 may be a hall sensor.

The camera module 1 may be shake-compensated by moving in a direction perpendicular to the optical axis (Z-axis) of the lens module 200.

The camera module 1 may include the second driving unit 700 generating driving force to move the lens module 200 in a direction perpendicular to the optical axis (Z-axis). The second driving unit 700 may include a first sub-driving unit 710 generating driving force to move the lens module 200 in the first axis (X-axis) direction, and a second sub-driving unit 730 generating driving force to move the lens module 200 in the second axis (Y-axis) direction.

The first sub-drive unit 710 may include a second magnet 711 and a second coil 713.

The second magnet 711 may be disposed on one side surface of the lens holder 230, and the second coil 713 may be disposed on one side surface of the housing 100 facing the one side surface of the lens holder 230 where the second magnet 711 is disposed. The second magnet 711 and the second coil 713 may face each other in a direction perpendicular to the optical axis (Z-axis).

One surface of the second magnet 711, for example, the surface facing the second coil 713, may be provided with an N-pole region (or S-pole region), a neutral region, and an S-pole region (or N-pole region) in that order along the second axis (Y-axis) direction corresponding to a length direction of the second magnet 711.

The second coil 713 may be mounted on the main board 900 and disposed in the housing 100. The housing 100 may include a through-hole (hereinafter, fourth through-hole) 134 penetrating one side surface in which the second coil 713 may be disposed, and the second coil 713 may be exposed to the internal space of the housing 100 through the fourth through-hole 134 and may directly face the second magnet 711.

When power is applied to the second coil 713, driving force may be generated in the first axis (X-axis) direction, a direction that the second magnet 711 and the second coil 713 face each other, by the electromagnetic force between the second magnet 711 and the second coil 713. The lens holder 230 may be moved in the first axis (X-axis) direction by the driving force.

The second sub-drive unit 730 may include a third magnet 731 and a third coil 733.

The third magnet 731 may be disposed on one side surface of the lens holder 230, and the third coil 733 may be disposed on one side surface of the housing 100 facing the one side surface of the lens holder 230 where the third magnet 731 is disposed. For example, one side surface of the lens holder 230 on which the second magnet 711 is disposed and one side surface of the lens holder 230 on which the third magnet 731 is disposed may be perpendicular to each other. The third magnet 731 and the third coil 733 may face each other in a direction perpendicular to the optical axis (Z-axis).

One surface of the third magnet 731, for example, the surface facing the third coil 733, may be provided with an N-pole region (or S-pole region), a neutral region, and an S-pole region (or N-pole region) in that order along the first axis (X-axis) direction corresponding to a length direction of the third magnet 731.

The third coil 733 may be mounted on the main board 900 and disposed in the housing 100. The housing 100 may include a through-hole (hereinafter, a fifth through-hole) 135 penetrating one side surface in which a third coil 733 may be disposed, and the third coil 733 may be exposed to the internal space of the housing 100 through the fifth through-hole 135 and may directly face the third magnet 731.

When power is applied to the third coil 733, driving force may be generated in the second axis (Y-axis) direction, a direction that the third magnet 731 and the third coil 733 face each other, by the electromagnetic force between the third magnet 731 and the third coil 733. The lens holder 230 may be moved in the second axis (Y-axis) direction by the driving force.

A third ball group BG3 may be disposed between the carrier 400 and the frame 500. The third ball group BG3 may be disposed between the surfaces facing each other in the optical axis direction (Z-axis direction) of the carrier 400 and the frame 500 to reduce friction when the frame 500 moves relative to the carrier 400.

The third ball group BG3 may contain three or more balls. For example, the third ball group BG3 may contain three balls. The three balls may be respectively disposed at the corners of the frame 500 having a ‘ [symbol] ’ shape and may be accommodated in the guide grooves G3 and G4 formed in the carrier 400 and the frame 500.

A third guide groove G3 may be formed on the surface of the frame 500 facing the carrier 400 in the optical axis direction (Z-axis direction). The third guide groove G3 may be formed at each corner of the frame 500 where three balls of the third ball group BG3 are disposed, and the three balls may be individually accommodated in the third guide groove G3. A fourth guide groove G4 may be formed in the carrier 400 to face the third guide groove G3.

The third guide groove G3 and the fourth guide groove G4 may extend in the direction of the first axis (X-axis). Accordingly, the three balls of the third ball group BG3 may roll in the first axis (X-axis) direction while being accommodated in the third guide groove G3 and the fourth guide groove G4. Additionally, the three balls of the third ball group BG3 may form two contact points each with the third guide groove G3 and the fourth guide groove G4. Accordingly, the three balls of the third ball group BG3 may be restrained to roll only in the first axis (X-axis) direction while being disposed between the third guide groove G3 and the fourth guide groove G4.

A fourth ball group BG4 may be disposed between the frame 500 and the lens holder 230. The fourth ball group BG4 is disposed between the surfaces facing each other in the optical axis direction (Z-axis direction) of the frame 500 and the lens holder 230, thereby reducing friction when the lens holder 230 moves relative to the frame 500.

The fourth ball group BG4 may contain three or more balls. For example, the fourth ball group BG4 may contain three balls. The four balls may be disposed at each corner of the frame 500 having a ‘ [symbol] ’ shape. Therefore, the three balls of the fourth ball group BG4 may overlap with the three balls of the third ball group BG3 in the optical axis direction (Z-axis direction). The fourth ball group BG4 may be accommodated in the guide grooves G5 and G6 formed in the frame 500 and the lens holder 230.

A fifth guide groove G5 may be formed on the surface facing the lens holder 230 of the frame 500 in the optical axis direction (Z-axis direction). The fifth guide groove G5 may be formed at each corner of the frame 500 where three balls of the fourth ball group BG4 are disposed, and the three balls may be individually accommodated in the fifth guide groove G5. A sixth guide groove G6 may be formed in the lens holder 230 to face the fifth guide groove G5.

The fifth guide groove G5 and the sixth guide groove G6 may extend in the second axis (Y-axis) direction. Accordingly, the three balls of the fourth ball group BG4 may roll in the second axis (Y-axis) direction while being accommodated in the fifth guide groove G5 and the sixth guide groove G6. Additionally, the three balls of the fourth ball group BG4 may form two contact points each with the fifth guide groove G5 and the sixth guide groove G6. Accordingly, the three balls of the fourth ball group BG4 may be restrained to roll only in the second axis (Y-axis) direction while being disposed between the fifth guide groove G5 and the sixth guide groove G6.

A second yoke 717 and a third yoke 737 may be disposed in the frame 500. The second yoke 717 may be opposing the second magnet 711 in the optical axis direction (Z-axis direction), and the third yoke 737 may be opposing the third magnet 731 in the optical axis direction (Z-axis direction).

The second yoke 717 and the third yoke 737 may be formed of a material including a magnetic substance.

The second magnet 711 and the second yoke 717, and the third magnet 731 and the third yoke 737 may each generate attractive forces between themselves, and the attractive forces may act in a direction facing each other, that is, in the optical axis direction (Z-axis direction).

By the attractive force of the second magnet 711 and the second yoke 717, the third magnet 731 and the third yoke 737, the lens holder 230 may be supported in close contact with the frame 500 with the fourth ball group BG4 interposed therebetween, and the fourth ball group BG4 may also be prevented from coming off.

The second yoke 717 and the third yoke 737 may also be disposed on the carrier 400. In this case, by the attractive force of the second magnet 711 and the second yoke 717, the third magnet 731 and the third yoke 737, the lens holder 230 may be supported in close contact with the carrier 400 with the fourth ball group BG4, the frame 500, and the third ball group BG3 interposed therebetween, and the ball groups B3 and BG4 may also be prevented from coming off.

A second position sensor 715 and a third position sensor 735 detecting a position of the lens module 200 in the first axis (X-axis) direction and the second axis (Y-axis) direction, perpendicular to the optical axis direction (Z-axis direction) may be disposed in the housing 100. The second position sensor 715 and the third position sensor 735 may be disposed on the main board 900. The second position sensor 715 may be disposed on the same surface as the second coil 713 and face the neutral region of the second magnet 711, and the third position sensor 735 may be disposed on the same surface as the third coil 733 and face the neutral region of the third magnet 731.

The second position sensor 715 and the third position sensor 735 may detect the position of the lens module 200 in the first axis (X-axis) direction and the second axis (Y-axis) direction, perpendicular to the optical axis direction (Z-axis direction) by detecting changes in the magnetic field. In an embodiment, the second position sensor 715 and the third position sensor 735 may be hall sensors.

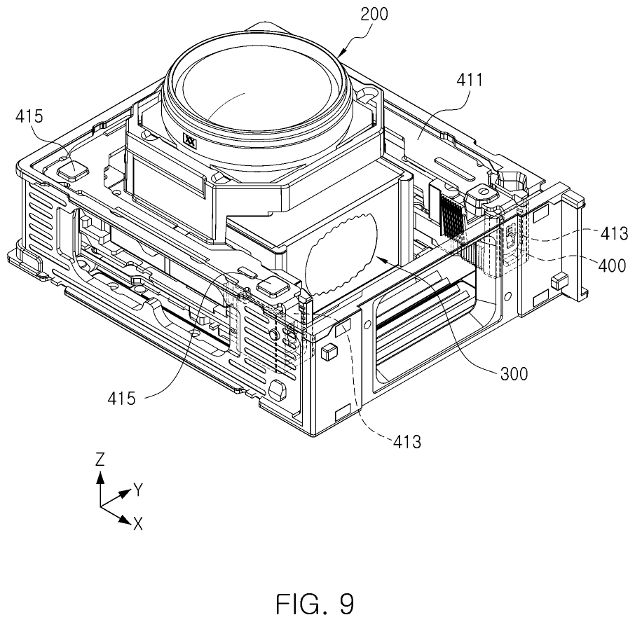

FIG. 9 is a perspective view illustrating a state in which a stopper is coupled to a carrier according to an embodiment of the present disclosure.

The camera module 1 may include a stopper 410 coupled to the carrier 400. The stopper 410 may include a cover portion 411 disposed on the upper portion of the carrier 400 and a coupling portion 413 disposed at each corner of the cover portion 411 and forming a coupling with the carrier 400.

The stopper 410 may be formed in a shape similar to the carrier 400 when viewed from the optical axis direction (Z-axis direction). That is, the cover portion 411 may have a ‘ [symbol] ’ shape.

The coupling portion 413 may be a portion extending from the cover portion 411 in the optical axis direction (Z-axis direction). The coupling portion 413 may extend in the optical axis direction (Z-axis direction) and may face a portion of the carrier 400 in a direction, perpendicular to the optical axis (Z-axis).

The coupling portion 413 may be coupled to the carrier 400 at a side surface of the carrier 400 facing the coupling portion 413 in a direction perpendicular to the optical axis (Z-axis).

The coupling portion 413 is formed in four pieces, two of which (a pair) may be coupled to one side surface of the carrier 400, and the remaining two (a pair) may be coupled to the other side surface of the carrier 400 that is parallel to the one side surface of the carrier 400.

The stopper 410 may be coupled to the carrier 400 via an adhesive at four bonding points.

The adhesive may be applied between the coupling portion 413 and the carrier 400, and as the adhesive is hardened, the stopper 410 may be firmly coupled to the carrier 400.

A plurality of dampers 415 may be disposed in the cover portion 411. The plurality of dampers 415 may be formed of a material such as urethane, rubber, silicone, and the like, but are not limited to a specific material.

The damper 415 may be of a type penetrating the cover portion 411 in the optical axis direction (Z-axis direction). The damper 415 may protrude in the optical axis direction (Z-axis direction) from the upper and lower surfaces of the cover portion 411. One side of the damper 415, a portion protruding from an upper surface of the cover portion 411, faces the case 110, and the other side, a portion protruding from a bottom surface of the cover portion 411, faces the lens holder 230. The one side of the damper 415 may collide with the case 110 instead of the carrier 400 when the carrier 400 moves in the optical axis direction (Z-axis direction). The other side of the damper 415 may collide with parts contained inside the carrier 400 instead of the carrier 400, when an external impact, or the like is applied.

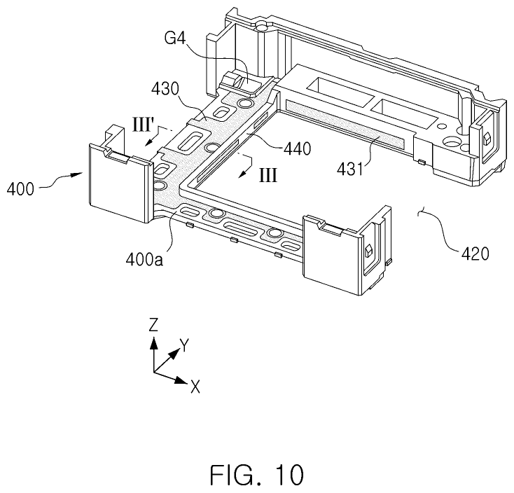

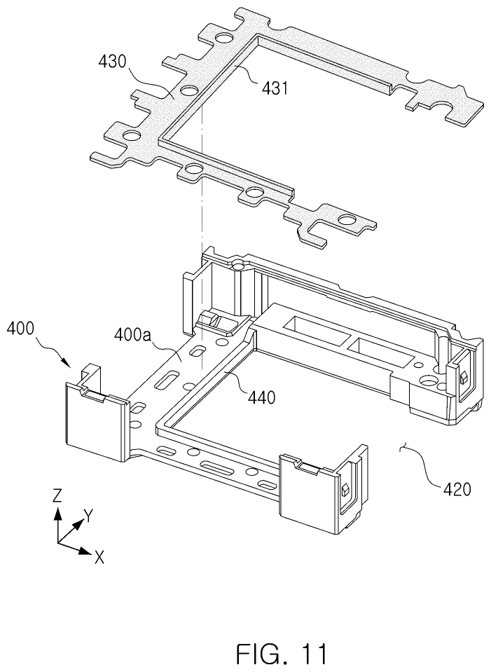

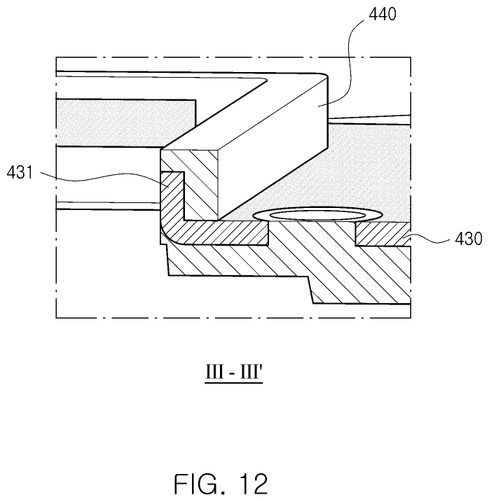

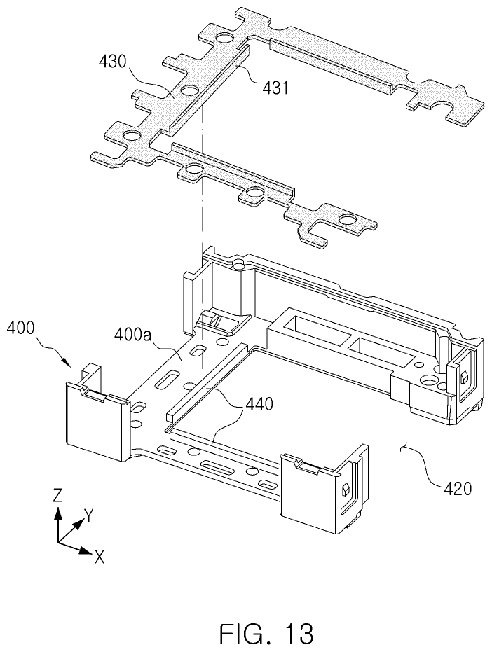

FIG. 10 is a perspective view of a carrier according to an embodiment of the present disclosure, FIG. 11 is an exploded perspective view of a carrier according to an embodiment of the present disclosure, FIG. 12 is a cross-sectional view taken along line III-III′ of FIG. 10, and FIG. 13 is an exploded perspective view of a carrier according to another embodiment of the present disclosure.

According to the present disclosure, the carrier 400 may include an opening portion (window) 420 formed on one side so that a path of light emitted from the exit surface 313 of the reflective member 310 is not obstructed. As the carrier 400 has an opening portion 420, it may have a ‘ [symbol] ’ shape when viewed from the optical axis direction (Z-axis direction) as described above.

A reinforcing member 430 may be disposed on the carrier 400. The reinforcing member 430 may contribute in supplementing the structural rigidity of the carrier 400 having an open shape on one side.

The reinforcing member 430 may be formed of a material different from that of the carrier 400. The reinforcing member 430 may be formed of a material having superior rigidity to the carrier 400. For example, the carrier 400 may be formed of a plastic material (for example, polycarbonate, PC), and the reinforcing member 430 may be formed of a metal material (for example, stainless steel, SUS). However, the material of the carrier 400 and reinforcing member 430 is not limited thereto.

The reinforcing member 430 is in the form of a thin plate and may be disposed on a bottom surface 400a of the carrier 400. The reinforcing member 430 may be formed in a ‘ [symbol] ’ shape following the shape of the bottom surface 400a of the carrier 400. That is, the reinforcing member 430 may have a ‘ [symbol] ’ shape when viewed from the optical axis direction (Z-axis direction).

The reinforcing member 430 may be inserted into the bottom surface 400a of the carrier 400, and a portion of the reinforcing member 430 may be exposed to the outside.

The reinforcing member 430 may include a rib 431 extending in a folded direction in the optical axis direction (Z-axis direction) along at least a portion of the internal edge. The reinforcing member 430 may have an external edge and an internal edge, and the external edge of the reinforcing member 430 may refer to an edge portion adjacent to the housing 110, and the internal edge of the reinforcing member 430 may refer to an edge portion adjacent to the optical axis (Z-axis) or the reflective member 310. The rib 431 may be bent from the internal edge of the reinforcing member 430 toward an upper lens module 200.

The carrier 400 may include a protrusion 440 formed along at least a portion of the internal edge. The protrusion 440 may be a portion protruding further in the optical axis direction (Z-axis direction) than the bottom surface 400a of the carrier 400 on which the reinforcing member 430 is disposed. The protrusion 440 may be folded from the internal edge toward the upper lens module 200. The rib 431 may be disposed on the protrusion 440 of the carrier 400, and a portion of the rib 431 may be exposed to the outside.

The reinforcing member 430 (including the rib 431) may be provided integrally with the carrier 400. For example, the reinforcing member 430 and the carrier 400 may be provided as a single piece by being molded using an insert injection molding method.

The carrier 400 may include the protrusion 440 protruding in the optical axis direction (Z-axis direction) from the bottom surface 400a of the carrier 400, and the reinforcing member 430 includes the rib 431 extending to the protrusion 440, thereby supplementing rigidity in the horizontal and vertical directions, thereby effectively preventing deformation of the carrier 400 when the stopper 410 is coupled.

In addition, since the contact area between the carrier 400 and the reinforcing member 430 is extended to the protrusion 440 and the rib 431, the fixing force between the carrier 400 and the reinforcing member 430 may be improved.

In an embodiment, the protrusion 440 may be formed continuously along the internal edge of the carrier 400, and the rib 431 may be formed continuously along the internal edge of the reinforcing member 430.

In another embodiment, the protrusion 440 may be formed discontinuously along the internal edge of the carrier 400, and similarly, the rib 431 may be formed discontinuously along the internal edge of the reinforcing member 430.

The protrusion 440 may include a plurality of parts spaced along the internal edge of the carrier 400. The protrusion 440 may be omitted from the corner portion of the internal edge of the carrier 400 and may be formed on each of the three sides of the internal edge of the carrier 400. That is, the protrusion 440 may include three parts. Similar to the protrusion 440, the rib 431 is also omitted from the corner portion of the internal edge of the reinforcing member 430 and may include a plurality of spaced parts. The ribs 431 may be formed on each of the three sides of the internal edge of the reinforcing member 430 and may include three or more parts. Each part of the protrusion 440 may have one or more parts of the rib 431 disposed thereon.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing in which a reflective member is disposed;
a lens module disposed on an object-side of the reflective member;
a carrier disposed to surround the reflective member; and
an image sensor on which light emitted from the reflective member is incident,
wherein the carrier comprises an opening portion on one side so that the reflective member and the image sensor directly face each other, and
wherein a reinforcing member is disposed on at least one surface of the carrier and is formed of a material having higher rigidity than that of the carrier.

2. The camera module of claim 1, wherein the reflective member and the lens module are disposed in an optical axis direction, and the reflective member and the image sensor are disposed in a direction perpendicular to an optical axis.

3. The camera module of claim 1, wherein the reflective member comprises:
an incident surface facing the lens module;
an exit surface facing the image sensor;
a reflective surface disposed obliquely relative to the incident surface and the exit surface; and
two side surfaces that are disposed parallel to each other while contacting the incident surface, the exit surface, and the reflective surface,
wherein the carrier is disposed to surround the reflective surface and the two side surfaces.

4. The camera module of claim 1, wherein the reinforcing member is disposed on one surface perpendicular to an optical axis of the carrier.

5. The camera module of claim 4, wherein the one surface of the carrier has a ‘ [symbol] ’ shape when viewed from an optical axis direction, and the reinforcing member has a shape corresponding to the one surface of the carrier.

6. The camera module of claim 4, wherein the reinforcing member comprises:
a first external edge adjacent to the housing and a first internal edge adjacent to the reflective member; and
a rib extending in an optical axis direction from at least a portion of the first internal edge.

7. The camera module of claim 6, wherein the carrier further comprises:
a second external edge adjacent to the housing and a second internal edge adjacent to the reflective member; and
a protrusion protruding in the optical axis direction from at least a portion of the second internal edge, and
wherein the rib is disposed on the protrusion.

8. The camera module of claim 7, wherein an extension direction of the rib and a protrusion direction of the protrusion are in a direction approaching the lens module.

9. The camera module of claim 1, wherein the reinforcing member is formed integrally with the carrier.

10. The camera module of claim 1, wherein the lens module is disposed on the carrier.

11. A camera module comprising:
a housing in which a reflective member is disposed;
a carrier disposed in the housing and configured to move in an optical axis direction relative to the housing together with a lens module; and
a stopper coupled to the carrier,
wherein the carrier has a shape in which one side is open in a direction perpendicular to an optical axis, and
wherein a reinforcing member is disposed on the carrier and is formed of a material having higher rigidity than that of the carrier.

12. The camera module of claim 11, wherein the stopper comprises:
a cover portion covering an upper portion of the carrier; and
a plurality of coupling portions extended in the optical axis direction from the cover portion and disposed to face the carrier in the direction perpendicular to the optical axis, and
wherein the stopper is coupled to the carrier through the plurality of coupling portions.

13. The camera module of claim 11, wherein the reinforcing member is disposed on a bottom surface of the carrier, and
wherein the bottom surface of the carrier and the reinforcing member disposed on the bottom surface of the carrier have a ‘ [symbol] ’ shape when viewed from the optical axis direction.

14. The camera module of claim 13, wherein the reinforcing member further comprises a rib that is bent and extended in the optical axis direction at a portion of the reinforcing member that is disposed on the bottom surface of the carrier.

15. The camera module of claim 14, wherein the carrier further comprises a protrusion protruding in the optical axis direction from the bottom surface of the carrier, and
wherein the rib is disposed on the protrusion.

16. The camera module of claim 15, wherein the reinforcing member further comprises a first external edge adjacent to a housing and a first internal edge adjacent to the optical axis, and
wherein the rib is disposed along at least a portion of the first internal edge of the reinforcing member.

17. The camera module of claim 15, wherein the carrier comprises a second external edge adjacent to the housing and a second internal edge adjacent to the optical axis, and
wherein the protrusion is disposed along at least a portion of the second internal edge of the carrier.

18. The camera module of claim 15, wherein the reinforcing member is formed integrally with the carrier.

19. The camera module of claim 11, further comprising:
the reflective member disposed in the housing; and
an image sensor spaced apart from the reflective member in the direction perpendicular to the optical axis,
wherein the reflective member and the image sensor directly face each other in the direction perpendicular to the optical axis, through the one open side of the carrier.

20. The camera module of claim 11, wherein the lens module is configured to move in a first axis direction perpendicular to the optical axis direction and a second axis direction perpendicular to the optical axis direction and the first axis direction relative to the carrier.
